(19) United States
(12) Patent Application Publication
(10) Pub. No.: US 2015/0112791 A1
(43) Pub. Date: Apr. 23, 2015

(54) MOBILE USER, ACTIVITY AND APPLICATION PROFILING

(71) Applicant: Quettra, Inc., Milpitas, CA (US)

(72) Inventor: Ankit Jain, Milpitas, CA (US)

(73) Assignee: Quettra, Inc., Milpitas, CA (US)

(21) Appl. No.: 14/287,000

(22) Filed: May 24, 2014

Related U.S. Application Data
(60) Provisional application No. 61/893,201, filed on Oct. 19, 2013.

(51) Int. Cl. G06Q 30/02; H04W 4/00; H04W 24/00

(52) U.S. Cl. CPC G06Q 30/0269; H04W 24/00; H04W 4/003; G06Q 30/0255; G06Q 30/0242; G06Q 30/0261
USPC 705/14.41; 455/405; 705/14.53

(57) ABSTRACT

Methods and systems for user, activity and application profiling for a mobile device are provided. According to one embodiment, activity stream data is received by an activity monitoring module running on a mobile device. The activity stream data includes information regarding usage of one or more applications installed on the mobile device. The activity stream data is provided by the activity monitoring module to a central server that collects activity stream data from multiple mobile devices, including the mobile device. The collected activity stream data is processed by the central server in conjunction with auxiliary data to create derived mobile user activity profiles for users of the mobile devices.

### CROSS-REFERENCE TO RELATED APPLICATIONS

This application claims the benefit of U.S. Provisional Application No. 61/893,201, filed Oct. 19, 2013, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2013-2014, Quettra, Inc.

Trademarks and brands used in this document as examples are the property of their respective owners.

### BACKGROUND

1. Field

Embodiments of the present invention relate generally to mobile devices and applications running thereon. More specifically, embodiments of the present invention relate to profiling of users, their activities and detailed application usage on mobile devices.

2. Description of the Related Art

Mobile computing devices have been growing in usage in the past decades. Users have been switching from using traditional media, such as magazines and TV, to mobile devices for entertainment, education, navigation, productivity, social networking and communication besides other uses.

While activity profiling in the personal computer world has been well understood, the same in the area of mobile devices is still developing. Activity profiling in the personal computer world is primarily done via browser cookies. These cookies can be used to track the user behavior as the user moves from one website to another or comes back to the same site. Activity profiling in the personal computer world is also done by asking the user to sign-on to a network such as Google, Yahoo, MSN, Facebook, Twitter, LinkedIn etc. The networks can then identify the user on outside of their primary sites where they have their traces.

For mobile devices, the primary access to the Internet is not necessarily done via web browsers but via applications. These applications by their nature do not use browser cookies and do not have a way of sharing an identity on top of which to build a profile. This is primarily how the current generation of mobile operating systems has evolved to isolate one application from another. Thus, an anonymous, safe and secure way to determine the user activity and profile is not very well understood or available for mobile devices.

From many perspectives, including manufacturers of these devices, advertisers, application developers, etc. it is important to know and understand what the mobile users do with their devices and applications.

An innovative way is required such that the usage of the device, the activities of the user, and the applications can be profiled. These can be used for further improving the device, applications, activities, advertisements and the experience to the user.

Such innovative ways to profile the users' activities and applications provide the benefit that these can be used by a plurality of stakeholders in the mobile space to understand, improve and personalize the mobile experience.

### SUMMARY

Methods and systems are described for user, activity and application profiling for a mobile device. According to one embodiment, activity stream data is received by an activity monitoring module running on a mobile device. The activity stream data includes information regarding usage of one or more applications installed on the mobile device. The activity stream data is provided by the activity monitoring module to a central server that collects activity stream data from multiple mobile devices, including the mobile device. The collected activity stream data is processed by the central server in conjunction with auxiliary data to create derived mobile user activity profiles for users of the mobile devices.

Other features of embodiments of the present disclosure will be apparent from accompanying drawings and from detailed description that follows.

### BRIEF DESCRIPTION OF THE DRAWINGS

FIG. 1 illustrates an exemplary mobile device with additional components for profiling in accordance with an embodiment of the present invention.

FIG. 2 illustrates exemplary activities that can be profiled for a mobile user to identify the user's behavior over time in accordance with an embodiment of the present invention.

FIG. 3 illustrates a network architecture and system components in accordance with an embodiment of the present invention.

FIG. 4 illustrates further details of a mobile client ads module in accordance with an embodiment of the present invention.

FIG. 5 illustrates further details of a server-side architecture in accordance with an embodiment of the present invention.

FIG. 6 illustrates further details of a server-side ads engine in accordance with an embodiment of the present invention.

FIG. 7 illustrates further details of a server-side analytics engine in accordance with an embodiment of the present invention.

FIG. 8 illustrates further details of a server-side data processing module in accordance with an embodiment the present invention.

FIG. 9 illustrates further details regarding raw user data in accordance with an embodiment of the present invention.

FIG. 10 illustrates an exemplary analytics dashboard for application developers in accordance with an embodiment of the present invention.

FIG. 11 illustrates an exemplary analytics dashboard for carriers or OEMs of mobile devices in accordance with an embodiment of the present invention.

FIG. 12 is an exemplary computer system in which or with which embodiments of the present invention may be utilized.

### DETAILED DESCRIPTION

Methods and systems are described for user, activity and application profiling for a mobile device. Embodiments of the present invention provide a solution that profiles a mobile user so that the user can be well understood. Embodiments of the present invention also provide a solution so that mobile applications and their usage can be better understood.

In workstation-based browsers, browser cookies are used to add, maintain and monitor state information by websites. Using cookies, websites determine how many visitors arrive, how many are new versus repeat visitors and how often a visitor has visited. Websites can store user preferences so that they can personalize the user experience. A plurality of websites can track a user as the user moves from one website to another using cookies. This works well if the user works only on a traditional personal computing device.

Mobile operating systems of the present day have evolved differently from workstation operating systems. There are no systems and methods provided for cookies that are shared across applications. In an exemplary situation, when a user clicks on a mobile advertisement, and is taken to another context of a mobile website, where the user completes a transaction, the user's identity is lost. This happens because there is no way to share identity of the user between the mobile application and the mobile web or another mobile application. Conversion tracking or activity tracking is thus not simple and sometimes done using inferred information in today's mobile devices while this is easily done using browser cookies on workstations.

Embodiments of the present invention, provide an architecture for activity collection and tracking on mobile devices. In an exemplary embodiment, applications and activities are monitored on mobile devices and the collected data is synchronized with a central server. The raw profile data from multiple devices and users is collected and processed centrally to create an aggregate profile of users, devices and applications in a way that different stakeholders can view and utilize the data for their particular needs.

In an exemplary usage model of embodiments of the present invention, mobile device manufacturers can understand when and where their users use the devices. The mobile device manufacturers can also understand what kinds of applications their end users are using. This can help manufacturers determine future product specifications and features better targeted to their users.

According to one embodiment, an activity stream is collected on the mobile device via the mobile operating system and forwarded to a central server where it is stored, processed and analyzed. The administrator of the server can obtain multiple types of reports, including those representing aggregate behavior of the users, activities and applications.

In an embodiment of the present invention, the activity stream feeds an advertisement management system in a way that a more personalized and relevant advertisement can be selected specific to a user based on the user's present and past activities.

In another embodiment, the activity stream data is processed to provide analytics that enable application developers to understand the flow of users into an out of their applications.

In yet another embodiment, the activity stream data is processed to provide analytics that enable users, such as mobile phone carriers and manufacturers, to better understand their user-base. This can improve their products and services to be better tailored for their specific users.

Embodiments of the present invention also include methods of analyzing and processing the large amounts of data collected regarding user, activity and application profiling so as to make the data useful to the stakeholders of the mobile eco-system.

In yet another exemplary usage scenario, application developers are provided with information that facilitates their understanding of how, where, when and what parts of their applications are being most used by the users.

In yet another exemplary usage scenario, advertisers are provided with information that facilitates their understanding of which applications are being most used by users and thus allowing advertisers to target those applications for ad delivery.

In another embodiment of the present invention, advertisers can understand their users better based on application usage of the users. Further, advertisers can segment users that ‘convert’ from those that do not by understanding the application usage patterns of the two sets of users.

An object of various embodiments of the present invention is to provide a method to track and record activity of a mobile device user. These activities typically relate to use of applications installed on the mobile device. An exemplary activity according to embodiments of the present invention is a verb, such as transferred money, wrote a note, bought a product, made a wish-list, downloaded video etc. The activities also have metadata associated with them, such as location, previous activity, previous application, phone state, accelerometer state, gyroscope state, and phone unique id etc. These and other types of metadata may also be recorded.

An additional object of various embodiments of the present invention is to centrally collect and aggregate this information, which can be subsequently used to provide analytics information to the various stakeholders of the system.

A further object of various embodiments of the present invention is to provide relevant advertisements to the mobile user based on the past and present activity profile.

### Terminology

Brief definitions of terms use throughout this application are given below.

The term “activity” generally refers to a process, an action or event that has been performed on or has occurred on a mobile device. Examples of activities include, but are not limited to, installing a mobile application, uninstalling a mobile application, using a mobile application and performing a specific task within a mobile application.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

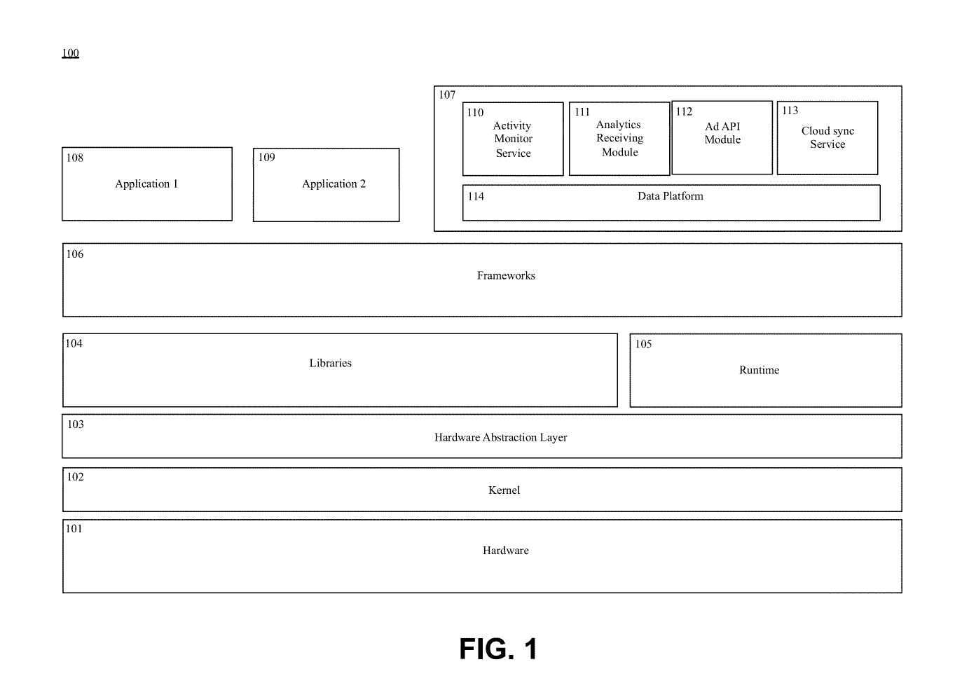

FIG. 1 illustrates operating system components of an exemplary mobile device 100 in accordance with an embodiment of the present invention. In the context of the present example, mobile device 100 includes hardware 101, an operating system kernel 102, a hardware abstraction layer 103, libraries 104, a runtime 105, application frameworks 106 and multiple applications 107-109. All components except application 107 (and its subcomponents) are typically available in a state-of-the-art mobile device.

Hardware 101 of mobile device 100 is controlled by kernel 102. Hardware Extraction Layer 103 is exposed by kernel 102 so that software components above, such as libraries 104 and runtime 105 can utilize them. Application Frameworks 106 provide core platform services so that applications, such as applications 108 and 109, can be developed. As all components except activity monitor application 107 are well described in the literature, for sake of brevity, they will not be described in detail here.

According to the present example, activity monitor application 107 is an on-device component that is added to perform user, application and device activity monitoring.

In one embodiment, activity monitor application 107 includes an activity monitor service 110, an analytics receiving module 111, an ad Application Programming Interface (API) Module 112, a cloud synchronization service 113 and a data platform 114. Depending upon the particular implementation, the activity monitoring functionality described herein may be incorporated within the mobile device OS (e.g., kernel 102). The activity monitoring functionality could also be a part of frameworks 106 or a library of libraries 104 that is then invoked by frameworks 106 or the applications layer.

Activity monitor service 110 is a process that may run in the background and log all activities and the context in which such activities took place. According to one embodiment, this context can include, but is not limited to, metadata associated with logged activities, such as one or more preceding activities, the mobile device location at the time of the activity at issue, a battery level at the time of the activity at issue, a time of day at the time the activity at issue was initiated and/or completed, information regarding concurrently active applications, accelerometer information, gyroscope information, and other sensor information. Activity monitor service 110 stores this context information locally using data platform API 114.

According to one embodiment, activity monitor service 110 can ascertain and store information regarding the exposed activities of applications (e.g., applications 108 and 109) running on mobile device 100 without any changes to them. For example, in the context of an Android mobile device, activity monitor service 110 may periodically (e.g., once per second or other configurable time period) retrieve one or more entries in the call stack via a getStackTrace( ) call and parse the returned StackTraceElements to identify currently running apps on the mobile device and their current state. In one embodiment, activity monitor service 110 runs in the background and becomes active only when other processing being performed by the mobile device falls below a predetermined or configurable threshold. Alternatively or additionally to making use of StackTrace information, activity monitor service 110 may retrieve information regarding currently running tasks and/or app processes from the Android ActivityManager, for example.

According to one embodiment, analytics receiving module 111 provides an API to application developers to store custom activities within data platform 114. This allows a third party application to integrate with activity monitor application 107 and allows them to store granular activities that they may be interested in, which otherwise may not be recorded via activity monitor service 110 because they are not exposed as activities externally within the operating system of mobile device 100.

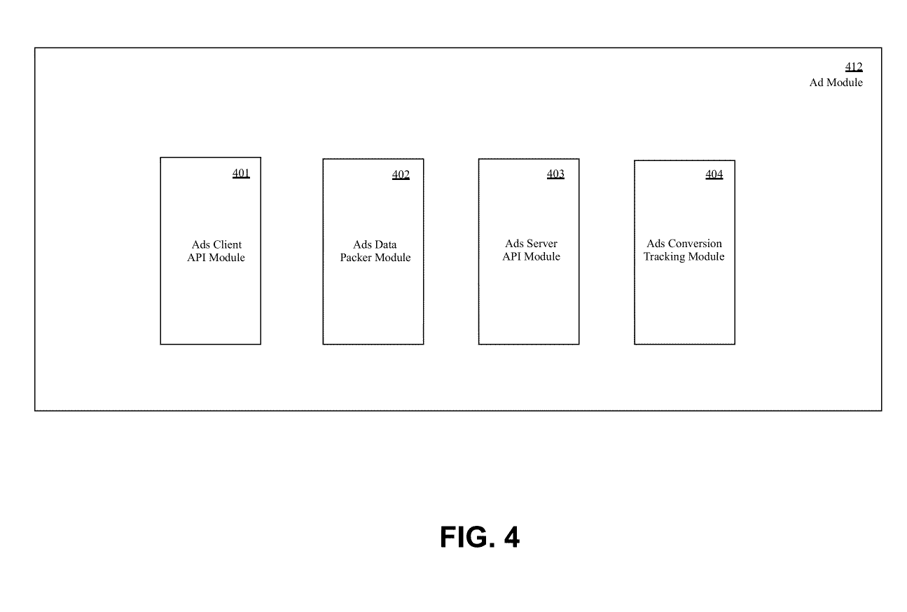

Ad API Module 112 may provide a set of APIs to manage the entire lifecycle of serving and tracking ads on mobile device 100. This may be done from the view of the advertiser, publisher as well as for the purposes of processing and viewing analytics. Ad API Module 112 is described in further detail below with reference to FIG. 4. According to various embodiments of the present invention, ad API module 112 can be used by third party applications (e.g., applications 108, 109) or by activity monitor application 107 itself.

In an exemplary embodiment, cloud synchronization service 113 provides infrastructure to synchronize the local data stored in data platform 114 with server based components in the cloud. The techniques to synchronize data from a local data store to the cloud are well-understood and hence are not described in further detail here.

In an exemplary embodiment, data platform 114 provides infrastructure to store and retrieve data for various components of activity monitor application 107. For example, data platform 114 may have the ability to interface with these components and the ability to purge data that has been synchronized or is no longer relevant.

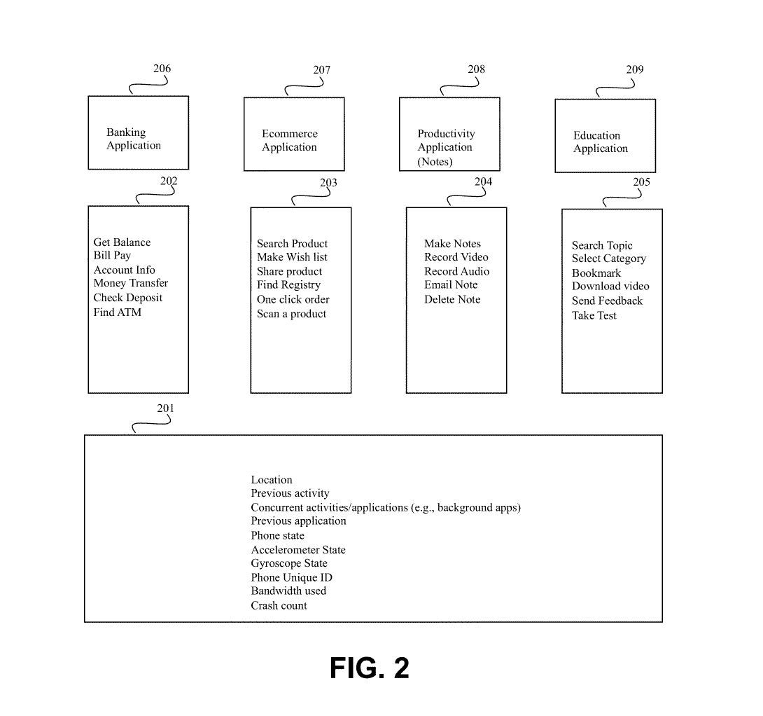

FIG. 2 illustrates exemplary activities 202-205 that can be profiled for a mobile user in accordance with an embodiment of the present invention. According to one embodiment, the activity monitor application 107 can monitor activities 202-205 of other applications 206-209 running on the mobile device (e.g., mobile device 100).

Data 201 represents meta-information collected for corresponding activities on the mobile device and stored in data platform 114, for example. According to one embodiment, meta-information includes, but is not limited to, location, previous activity, previous application, phone state, accelerometer state, gyroscope state, bandwidth used, crash count of the application at issue and a unique ID of the mobile device (e.g., a Unique Device Identifier (UDID) of an iOS device, a Media Access Control (MAC) address, an International Mobile Equipment Identify (IMEI), an Electronic Serial Number (ESN), a Mobile Equipment Identifier (MEID), a BB pin of a Blackberry mobile phone, a Dynamic Host Configuration Protocol (DHCP) Unique Identifier (DUID) of a Windows-based mobile device or the like).

Banking application 206 represents an exemplary banking application running on a mobile device. In the context of the present example, activities 202 corresponding to banking application 206 include, but are not limited to, Get Balance, Bill Pay, Account Info, Money Transfer, Check Deposit and Find ATMs.

Electronic commerce (e-commerce) application 207 represents an exemplary e-commerce application running on a mobile device. In the context of the present example, activities 203 corresponding to e-commerce application include, but are not limited to, Search Product, Make Wish list, Share product, Find Registry, One click order and Scan a product.

Productivity application 208 represents an exemplary productivity application (e.g., a note taking application) running on a mobile device. In the context of the present example, activities 204 corresponding to productivity application 208 include, but are not limited to, Make Notes, Record Video, Record Audio, Email Note and Delete Note.

Education application 209 represents an exemplary education application running on a mobile device. In the context of the present example, activities 205 corresponding to education application 209 include, but are not limited to, Search Topic, Select Category, Bookmark, Download video, Send Feedback and Take Test.

Applications 206, 207, 208, 209 described above are meant only to exemplify various possibilities. In no way should the aforementioned exemplary applications limit the scope of the present disclosure. Similarly activities 202, 203, 204 and 205 are meant to exemplify various possibilities.

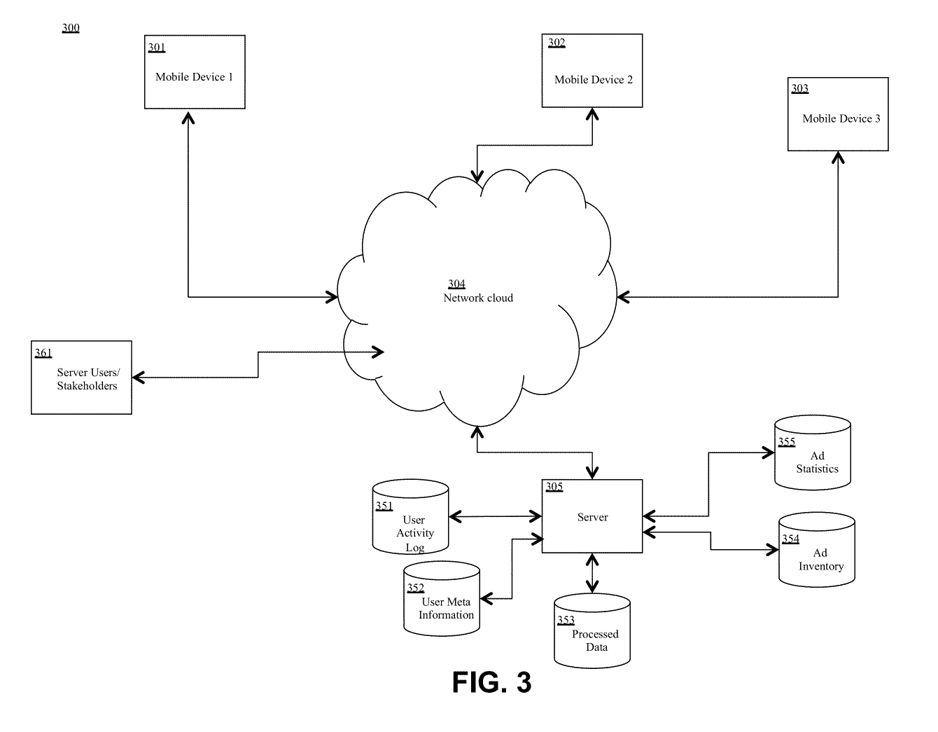

FIG. 3 illustrates a network architecture 300 and exemplary system components in accordance with an embodiment of the present invention. In the context of the present example, network architecture includes a network cloud 304 (e.g., one or more public or private networks, including a one or more cellular networks, the public switched telephone network, one or more enterprise networks and/or the Internet) to which multiple mobile devices 301-303 are coupled in communication.

According to one embodiment, a server (e.g., server 305) collects data from mobile devices 301-303 and facilitates the provision of personalized and relevant ads, ad conversion tracking, aggregate analytics as well as personalized advertisements based on the user's activities. Server 305 interfaces with mobile devices 301-303 via network cloud 304. Server 305 is coupled to multiple data stores, which may represent tables within a database or separate databases. In the present example, the data stores include a user activity log database 351, a user meta information database 353, a processed data database 353, an ad statistics database 355 and an ad inventory database 354. Server 305 receives activity logs from mobile devices 301-303 and stores them in a user activity log 351. Those of ordinary skill in the art will appreciate that server 305 may represent one or more virtual and/or physical machines at one location or distributed across multiple physical locations.

Server 305 collects meta information from mobile devices and stores the collected meta information with user meta information database 352. Meta information may be collected by server 305 when mobile devices 301-303 first connect to server 305 and/or periodically thereafter. Meta information may include, but is not limited to, device model, device operating system (OS), OS version, carrier, set of applications installed, usage statistics relating thereto, demographic data, information regarding the voice, data and/or messaging plan(s) enrolled in and/or usage thereof, presence or absence of certain types of content (e.g., video or music), etc. The meta information may be updated periodically to track changes in the users' state.

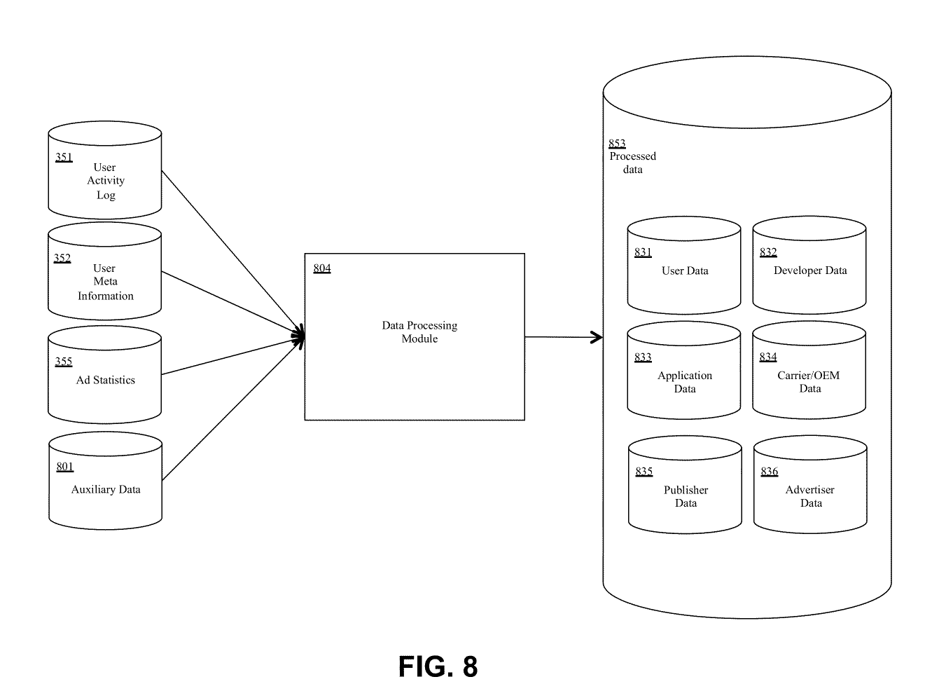

Server 305 processes the information stored in user activity log database 351 and the information stored in user meta information database 352 to create processed data that is stored in processed data database 353. An example of this data processing functionality is described in further detail below with reference to FIG. 8.

The processed data may include profiles of all users and applications associated with monitored mobile devices 301-303. The user profiles typically include a summary of past activities as well as activities that represent the system's view on each user. The application profiles similarly include details of various applications being monitored. The profiles may also be stored in processed data database 353. In one embodiment, one or both of the user profiles and the application profiles are generated offline and are only accessed in a read-only mode at run time.

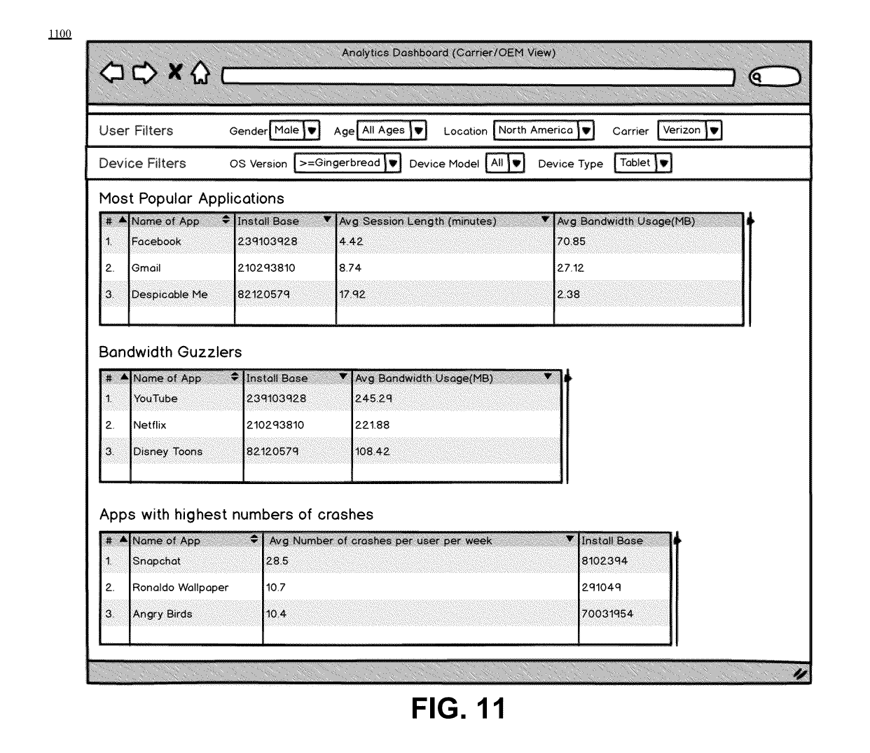

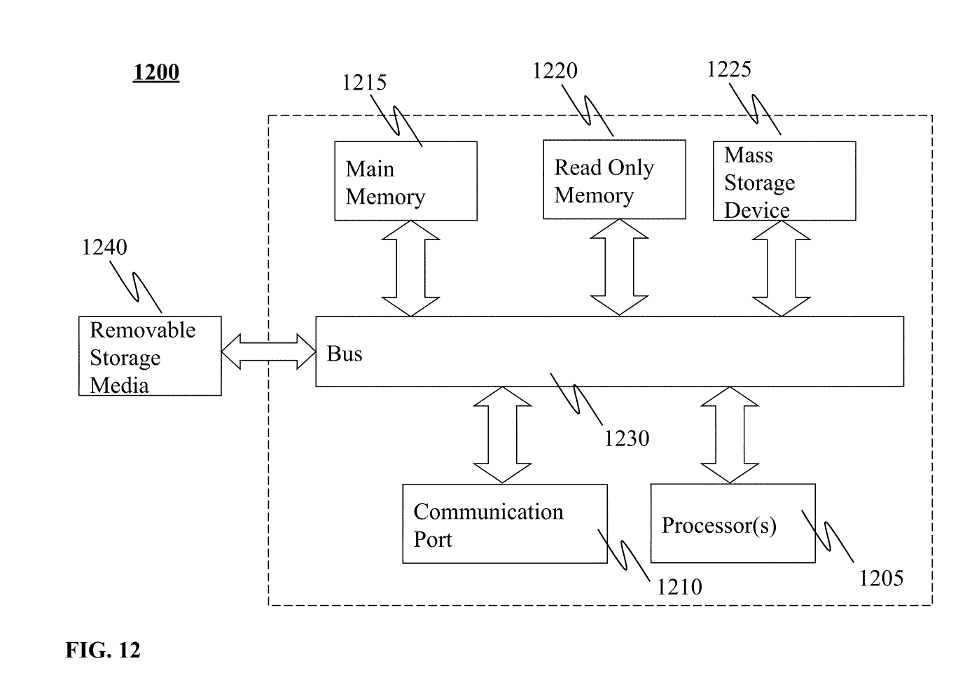

Server 305 also provides a way for its users/subscribers (e.g., server users/stakeholders 361) to remotely access parts of the processed data via network cloud 304. Exemplary analytics solutions for various stakeholders are described in further detail below with reference to FIGS. 11 and 12.

According to the present example, server 305 also provides a way to manage ad inventory database 354, which contains advertising inventory that can be shown to users of mobile devices 301-303. The ads displayed to the users may be based at least in part on user profiles extracted from their activities and the ad publisher's targeting criteria.

Server 305 also provides a way for its users/subscribers (e.g., server users/stakeholders 361) to collect and make use of feedback regarding ad performance. Ad performance statistics (e.g., clicks, impressions, clickthrough rate and the like) may be stored in ad statistics database 355. This information may be used by server users/stakeholders 361 to influence future ad serving and revenue optimization. This data may be stored in ad statistics database 355 and/or ad inventory database 354. Those skilled in the art will appreciate ad statistics database 355 and/or ad inventory database 354 may be associated with a third party advertising network or may be populated by a third party advertising network.

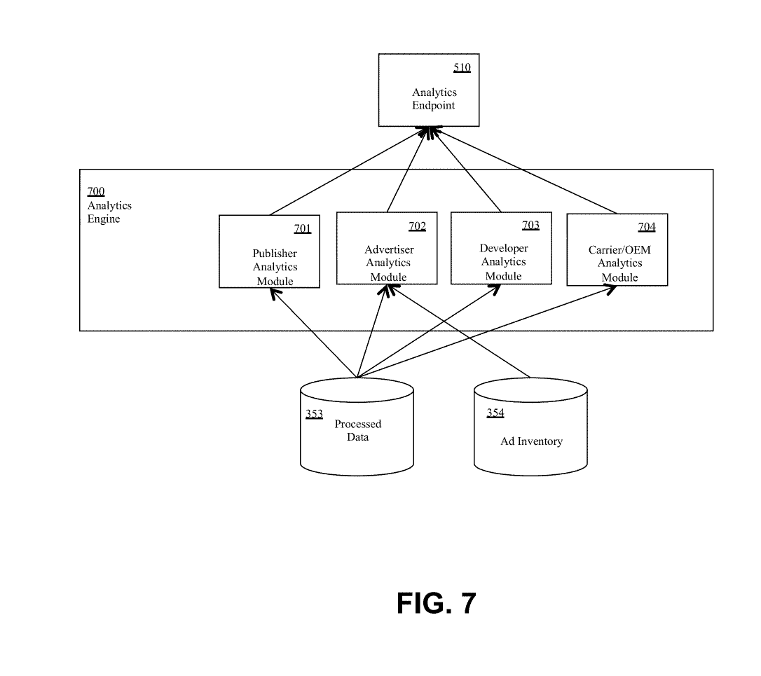

Server 305 may also includes logic to choose which advertisements to serve to mobile devices 301-303 based on appropriate policies and/or requirements specified by the advertisers as well as the algorithms included to maximize the revenue for all stakeholders 361. Exemplary logic to filter the available inventory down to the appropriate ones for the user at hand as well as the logic to choose the order in which ads are displayed to a particular user are described further below with reference to FIG. 7.

FIG. 4 shows a detailed breakdown of an ad module 412 in accordance with an embodiment of the present invention. Ad module 412 may represent an example of ad API module 112 described earlier with reference to FIG. 1. In the context of the present example, ad module 412 provides a set of APIs to manage the entire lifecycle of serving and tracking ads on the mobile device from the view of the advertiser, publisher as well as for the purposes of processing and viewing analytics.

In one embodiment, ad module 412 provides an ads client API module 401, an ads data packet module 402, an ads server API module 403 and an ads conversion tracking module 404. Ads client API module 401 may represent a set of APIs through which application developers may fetch advertisements to be displayed in their applications. The ads client API module 401 may also provide an interface that enables application developers to provide the advertisement engine with extra information that can be used to improve the relevance of the ads shown.

In one embodiment, ads data packer module 402 packs the data provided by the application developer via ads client API module 401 and combines it with recent activities as retrieved from data platform 114 and forwards the request to ads server API Module 403.

Ads server API module 403 may be used to send the data packed by ads data packer module 402 to retrieve targeted advertisements from server 305 via network cloud 304. The server APIs provided by ads server API module 403 enable mobile devices 301-303 to communicate with the ad infrastructure and ad inventory residing in the cloud.

In one embodiment, ads conversion tracking module 404 enables the on-device activity monitor application 107 to track the advertisements that led to clicks and conversions and store this conversion data locally within data platform 114. The techniques necessary to achieve this are well known to those skilled in the art and thus are not further described herein.

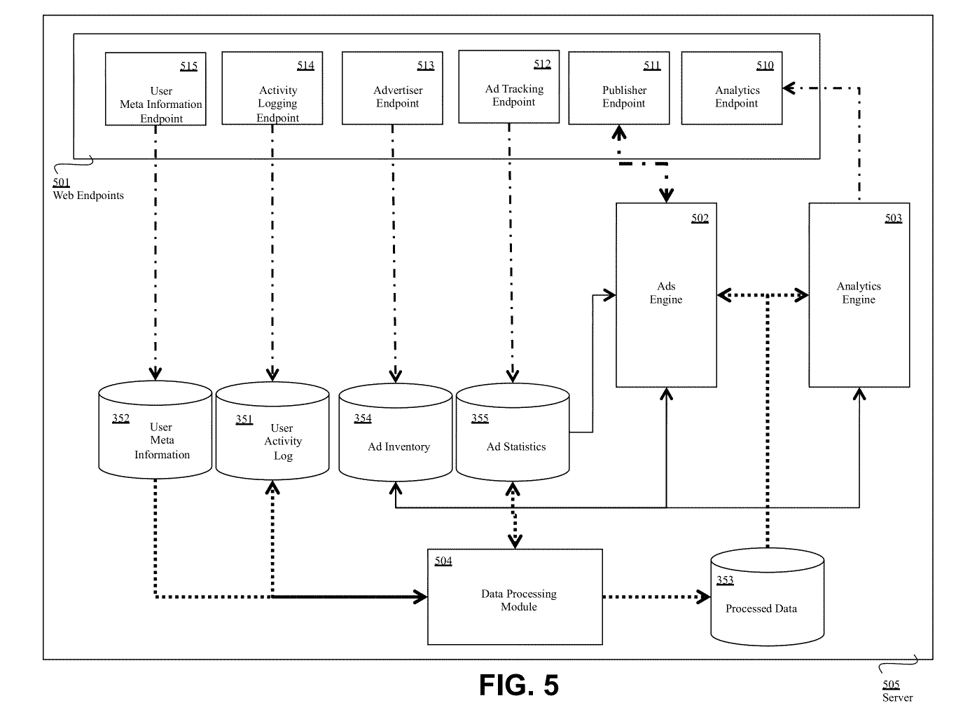

FIG. 5 illustrates exemplary functional units of a server 505 in accordance with an embodiment of the present invention. According to the present example, server 505 (which represents an example of server 305 of FIG. 3), includes multiple web-endpoints 501 so that clients and users can access services from server 505. Server 505 also includes database, logs and engines to process and store data. In one embodiment, server 505 includes the major functional units described below.

Server 505 includes a number of Web endpoints 501 that enable different devices, users and stakeholders on the network to perform actions relevant to their functions/business via the cloud. Examples are detailed below.

Server 505 includes an analytics endpoint 510 that enables publishers, advertisers, developers and carriers/Original Equipment Manufacturers (OEMs) to view and analyze data relevant to them using an analytics engine 503. An exemplary analytics engine 503 is described in further detail below with reference to FIG. 7.

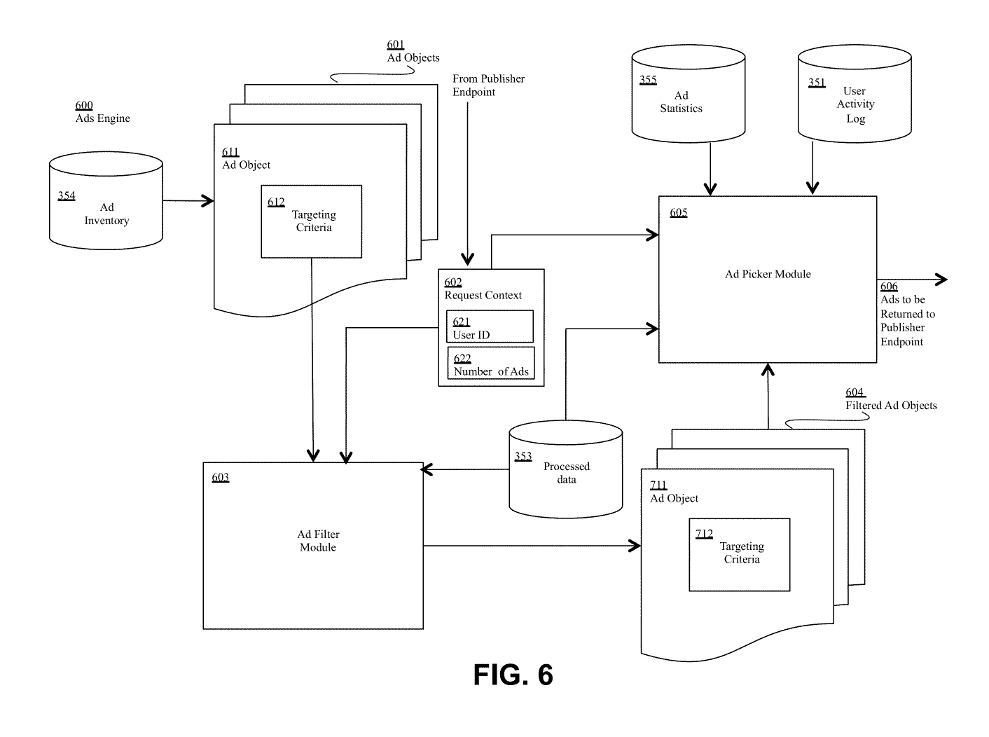

Server 505 also includes a publisher endpoint 511 that enables publishers to request ads from Ads engine 502 via ads client API module 401. An example of ads engine 502 is described further below with reference to FIG. 6.

Yet another endpoint included in server 505 is an ad tracking endpoint 512 which enables ads conversion tracking module 404 to send tracking information about ads displayed to the mobile users. The tracking information may include data about ads, such as the context in which they were shown, clicks, conversions, dismissals, etc. The tracking information may be stored locally in ad statistics database 355, for example.

Server 505 also includes an advertiser endpoint 513 through which advertisers may add new inventory or modify existing inventory from the current state as represented in ad inventory database 354. The techniques necessary to achieve this are well known to those skilled in the art and thus are not further described herein.

Server 505 also includes an activity logging endpoint 514 which receives activity logs from monitored mobile devices via cloud sync service 113, for example. The activity logs may be stored within user activity log database 351.

Server 505 also includes a user meta information endpoint 515 which receives information about users from monitored mobile devices via cloud sync service 113, for example. The user meta information may be stored within user meta information database 352.

Server 505 includes a data processing module 504 for processing the user meta information, user activity log data and ad statistics and generates process data. According to one embodiment, this is an off-line and batch activity. The processed data stored in processed data database 353, for example, is then utilized by ads engine 502 and analytics engine 503. Data processing engine 504 is described in further detail below with reference to FIG. 8.

FIG. 6 illustrates further details and exemplary processes of a server-side ads engine 600 in accordance with an embodiment of the present invention. Ads engine 600 may represent an example of ads engine 502 described earlier with reference to FIG. 5. In one embodiment, a publisher makes request for one or more ads via a publisher endpoint (e.g., publisher endpoint 511). The purpose of ads engine 600 is to return the right ordered list of ads 606. The ad request is summarized in an ads request context 602. An exemplary request context 602 received includes a unique identifier for the user to be targeted 621 and the number of ads being requested 622. According to one embodiment processed data from processed data database 353 and recent activities of the targeted user 621 from user activity log 351 are used to build the ordered list 606.

Ad objects 601 is a module that extracts all the available ad inventory in the form of ad objects responsive to receipt of the publisher ad request. For example, ad objects 601 only returns ad objects from advertisers that still have remaining ad budgets to spend. Each individual ad object 611 contains a set of targeting criteria 612 representing the users the advertiser would like to target for that specific ad object. Targeting criteria 612 can include, but is not limited to, user meta information, such as location, device type, operating system version, derived user profile characteristics as well as certain recent user actions.

Ad filter Module 603 filters the available ad objects 601 clown to a set of filtered ad objects 604. The filtering process employed may include processing each object 611 by checking whether the user characteristics, as represented in processed data database 353 and recent actions from user activity log database 351 meet the requirements of the specified targeting criteria 612.

According to an embodiment, an ad picker module 605 is responsible for trimming down the list of filtered ad objects 604 that not only are available at the time of the publisher ad request but also match the user and application characteristics found in processed data database 353 to the number of ads requested and according to the metrics the specific ad engine is trying to maximize. Ad picker module 605 may also access and use statistics about each ad object 711 and advertiser from ad statistics database 355 in computing the ordered list of ads to be returned 606.

FIG. 7 illustrates further details of a server-side analytics engine 700 in accordance with an embodiment of the present invention. Analytics engine 700 may represent an example of analytics engine 503 described earlier with reference to FIG. 5. In the context of the present example, details are provided regarding various exemplary analytics components. In one embodiment, analytics engine 700 is a batch processing engine that enables different stakeholders to interact with, analyze and visualize data that they have permission to access.

Analytics endpoint 510 services requests from different stakeholders. For purposes of illustration four sets of exemplary stakeholders are represented in the context of the present example: publishers, advertisers, developers and carriers/OEMs. Depending on the stakeholder, the analytics requests are forwarded to the appropriate module (e.g., publisher analytics module 701, advertiser analytics module 702, developer analytics module 703 or carrier/OEM analytics module 704).

Publisher analytics module 701 is used by ad publishers, such as app developers or website owners to check the performance of advertisements shown on their destinations. To fulfill this, publisher analytics module may make use of processed data database 353.

Advertiser analytics module 702 is used by advertisers, such as brands, agencies and app marketers to track the performance of their campaigns as well as check the progress of any outstanding inventory. To fulfill this, advertiser analytics module may make use of ad inventory database 353 in addition to processed data database 354.

Developer analytics module 703 is used by application developers to check the performance of their applications and track metrics, which may include, but are not limited to, daily active users, monthly active users, average session length as well as any custom events they might have registered using analytics receiving module 111. To fulfill this, developer analytics module may make use of processed data database 353.

Carrier/OEM analytics module 704 is used by mobile carriers as well as OEMs to gain business intelligence about application usage by product or service customers. Exemplary OEMs include Samsung, Motorola and HTC while exemplary carriers include AT&T, Verizon, Vodafone and Airtel. To these entities, business intelligence metrics may include, but is not limited to, daily active users, monthly active users, average data usage, average mobile talk time, top applications by usage, top applications by install, top crashing applications, top applications by bandwidth, etc. To fulfill this, carrier/OEM analytics module may make use of processed data database 353.

The techniques to implement analytics modules 701, 702, 703 and 704 are well known to those skilled in the art and thus are not further described herein. However, exemplary processes for data creation and interactions of data are described below.

FIG. 8 illustrates further details of a server-side data processing module 804 in accordance with an embodiment of the present invention. Data processing module 804 may represent an example of data processing module 504 described earlier with reference to FIG. 5. The figure illustrates details of processing multiple logs from clients and meta-information to create processed data according to an embodiment of the present invention. In the context of the present example, the process of combining data from user activity log database 351 with data from user meta information database 352, ad statistics database 355 and an auxiliary data database 801 to create data to be stored within processed data database 353 is illustrated.

FIG. 8 illustrates a process of combining the User Activity Log 351 with User Meta Information 352, Ad statistics 355, and the Auxiliary Data 801 to create Processed. Data 353 in accordance with an embodiment of the present invention. According to one embodiment, data processing module 804, generates processed data at fixed intervals through batch processes. In another exemplary implementation of the Data Processing Module 504, the module sets up watchers on the input tables/databases and creates the processed data in real time as and when certain new information is inserted or updated in any of the input tables/databases.

Auxiliary data database 801 includes any non-user-specific data that has been gathered about entities that represent a useful part of the profile. As an example, auxiliary data database 801 might include information about the Facebook application, describing it as a social networking and messaging application. In another example, auxiliary data database 801 might store properties about a location describing Starbucks as a coffee shop and a popular place for business meetings. The goal of this data is to combine it with user characteristics and application characteristics in order to crease derived user characteristics 903 that will be part of the processed data. For the examples previously mentioned, a user who uses the Facebook application may be described as having interest in social networking or messaging while a user who visits Starbucks might be described as having an affinity for business meetings or drinking coffee. A user who uses the Netflix application may be interested in online-entertainment. A user who uses technology related applications may be interested in technology and so on. Such user characteristics that include both raw and inferred data can be used to target advertisements to a set of users.

Processed data database 353 contains relevant information about each entity of interest to the various stakeholders of the system. Exemplary entities are users, application developers, applications, carriers/OEMs, publishers and advertisers. The data stored about entities varies based on the use case for each entity type. In the context of the present example, corresponding to each exemplary entity, there is a corresponding processed data store (e.g., user data store 831, developer data store 832, application data store 833, carrier/OEM data store 834, publisher data store 835 and advertiser data store 836.

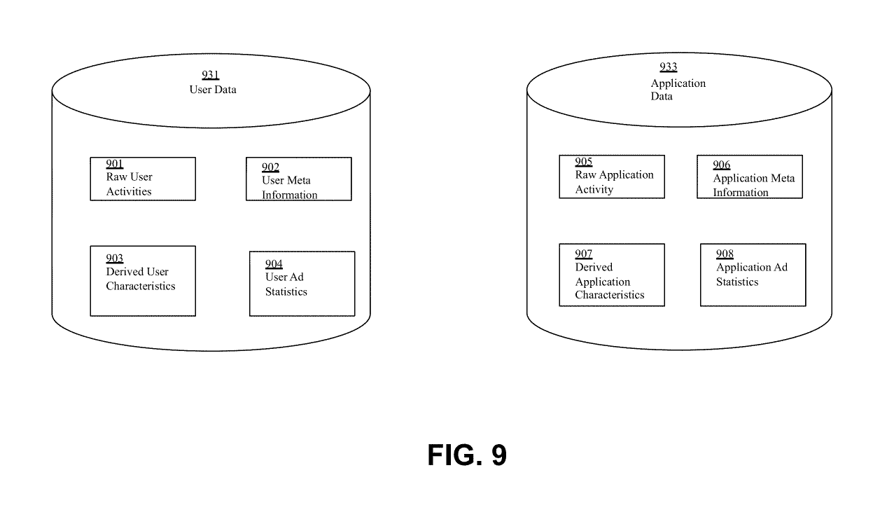

In the present example, each user entity has a summarized profile, meta information, derived user characteristics as well a set of most recent actions stored in user data store 831. User data is described in further detail below with reference to FIG. 9.

In the present example, each application developer has a summary of the statistics of each of their applications stored in developer data store 832 to enable analysis across their portfolio of applications. This may include custom events the application developer may have registered using analytics receiving module 111.

In the present example, activity monitoring service 110 can monitor each application without any changes to the underlying applications. Exemplary application data 833 includes daily active users, monthly active users, average session lengths, most used activity etc. for each application. Application data is described further below with reference to FIG. 9.

In the present example, each publisher has data available about the performance of ads from their destinations stored in publisher data store 835 while each advertiser has data available about the performance of their ad campaigns and creatives stored in advertiser data store 836.

FIG. 9 illustrates further details regarding raw user data in the form of a user data store 931 and an application data store 933 in accordance with an embodiment of the present invention. In one embodiment, both these data stores 931 and 933 are stored within processed data database 353. User data store 931 represents an example of user data store 831 and includes raw user activities 901, user meta information 902, derived user characteristics 903, as well as per-user ad statistics 904.

Derived user characteristics 903 stores tags related to each user depending on inferences that are made based on joining the available user activities with information from applications data store 933 and potentially other data about the user.

As an example, application meta-information 906 about the Facebook application may describe it as a social networking and messaging application. As such, when a user interacts with or otherwise performs sufficient Facebook activities, they may be tagged as a user interested in ‘social networking’ and/or ‘messaging’. This becomes a derived user characteristic 903 for the user.

In another example, auxiliary data might store properties about a location, e.g., Starbucks, characterized, as a coffee shop and a popular place for business meetings. When a user visits such a location a sufficient number of times according to user activity, a derived user characteristic 903 for such a user may be a user having an affinity for ‘business meetings’ and/or ‘drinking coffee’.

User ad statistics 904 contains interactions on a per-user basis with ads. These statistics may include, but are note limited to, ad impressions, ad interactions, ad clicks, ad conversions.

All or a subset of the data stored in user data store 931 may be used by ad picker module 605 to most optimally order the ads returned to publisher endpoint 511 by ads engine 502.

In the present example, application data store 933 similarly includes raw application activities 905, application meta-information 906, derived application characteristics 907, as well as per-application ad statistics 908.

Application ad statistics 908 contains information regarding interactions on a per-application basis with ads. These may include, but are not limited to, ad impressions, ad interactions, ad clicks and ad conversions.

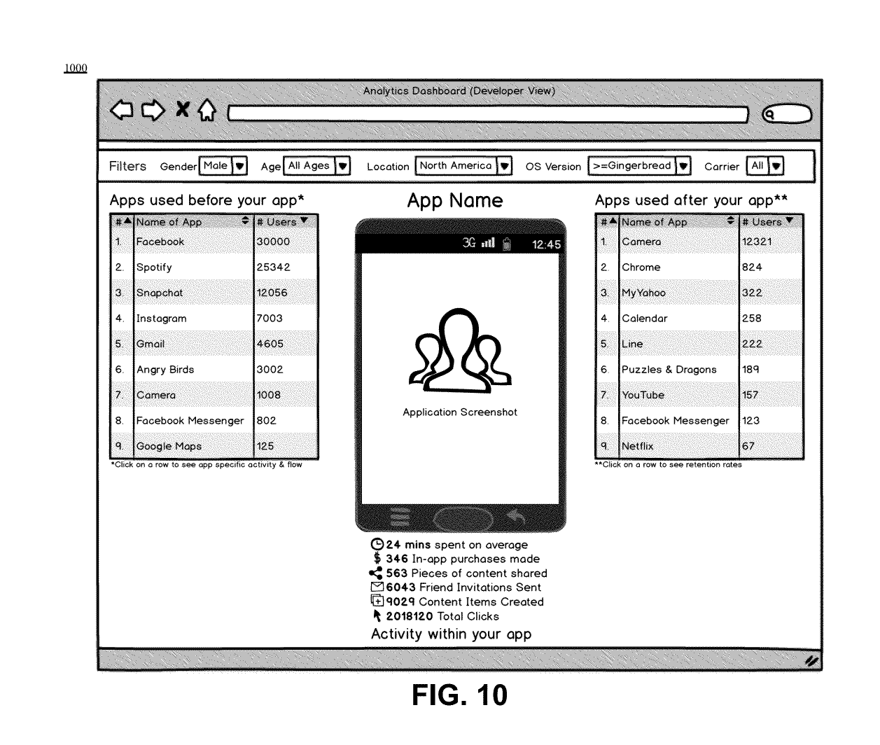

FIG. 10 illustrates an exemplary analytics dashboard 1000 for application developers in accordance with an embodiment of the present invention. Examples of how an application developer may use this system to gain insight into his/her applications are described with reference to analytics dashboard 1000, which may be accessible to the application developers via an analytics endpoint (e.g., analytics endpoint 510) provided within server 305. For example, the application developer may be provided with information regarding applications used before his/her application and/or used after his/her application. This insight helps the developer make modifications to optimize the applications. Additional insight may include, but is not limited to, metrics, such as session time, in-app purchases made, count of content shared, invites sent, content created and clicks. In addition, the developer can get a partial view of the metrics using filters such as gender, age, location, OS version, carrier etc. Further drilling down may include such details for a specific previously or subsequently used application. This may provide insight into loss of users to other applications which can be inferred from users not returning to the developer's applications.

FIG. 11 illustrates an exemplary analytics dashboard 1100 for carriers or OEMs of mobile devices in accordance with an embodiment of the present invention. Examples of how an OEM or carrier may use this system to gain insight into the devices, models, applications, carriers and users are described with reference to analytics dashboard 1100, which may be accessible to the OEM or carrier via an analytics endpoint (e.g., analytics endpoint 510) provided within server 305. Exemplary insights that the OEM gets include, most popular applications, bandwidth-heavy applications, and applications that crash. Further filtering of this data may be possible using user and/or device filters. User filters may include gender, age, location, carrier, etc. Device filters may include OS version, device model, device type etc.

FIG. 12 is an example of a computer system 1200 with which embodiments of the present disclosure may be utilized. Computer system 1200 may represent or form a part of a mobile device (e.g., mobile device 100 or 301-3-3), a server (e.g., server 305 or 505) or an end user or stakeholder workstation (e.g., server users/stakeholders 361).

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 1200 includes a bus 1230, a processor 1205, communication port 1210, a main memory 1215, a removable storage media 1240, a read only memory 1220 and a mass storage 1225. A person skilled in the art will appreciate that computer system 1200 may include more than one processor and communication ports.

Examples of processor 1205 include, but are not limited to, any known processor, such as mobile application processors or other processors designed for portable devices, such as the ARM Cortex™-A7, -A8 or A9 processor of ARM Holdings, one or more of Texas Instruments' OMAP family of processors (e.g., the OMAP2430 or the OMAPV2230), an Intel® 80386 processor, and Intel PXA901 processor, an Intel Itanium® or Itanium 2 processor(s), or AMD® Opteron® or Athlon MP® processor(s), or Motorola® lines of processors. Notably, future mobile devices are likely to have at least two processors, one for carrier processing and one for application processing.

Communication port 1210 can be any of an RS-232 port for use with a modem based dialup connection, a 10/100 Ethernet port, a Gigabit or 10 Gigabit port using copper or fiber, a serial port, a parallel port, or other existing or future ports. Communication port 1210 may be chosen depending on a network, such a Local Area Network (LAN), Wide Area Network (WAN), or any network to which computer system 1200 connects.

Memory 1215 can be Random Access Memory (RAM), or any other dynamic storage device commonly known in the art. Read only memory 1220 can be any static storage device(s) such as, but not limited to, a Programmable Read Only Memory (PROM) chips for storing static information such as start-up or BIOS instructions for processor 1205.

Mass storage 1225 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1230 communicatively couples processor(s) 1205 with the other memory, storage and communication blocks. Bus 1230 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1205 to system memory.

Optionally, in the case of a server and typically in the case of a fixed client device, such as a desktop computer, operator and administrative interfaces, such as a display, keyboard, and a cursor control device, may also be coupled to bus 1230 to support direct operator interaction with computer system 1200. Other operator and administrative interfaces can be provided through network connections connected through communication port 1210.

Removable storage media 1240 can be any kind of external hard-drives, floppy drives, IOMEGA® Zip Drives, Compact Disc-Read Only Memory (CD-ROM), MultiMedia Cards (MMCs), secure digital (SD) cards, such as miniSD and microSD cards, Compact Disc-Re-Writable (CD-RW), Digital Video Disk-Read Only Memory (DVD-ROM).

Depending upon the particular implementation, computer system 1200 may also include one or more other integrated or externally connected devices that serve as sources for context data. For example, sources of context data include, but are not limited to, blue tooth devices, USB devices, flash drives, fingerprint readers or other biometric devices, heart rate monitors and the like. A GPS receiver that provides real-time GPS location data is another example of an integrated or externally connected device that might provide context for mobile user activities. The GPS receiver may include its own processor and/or memory or utilize the host processor(s).

Components described above are meant only to exemplify various possibilities. In no way should the aforementioned exemplary computer system limit the scope of the present disclosure.

Although embodiments of the present invention and their various advantages have been described in detail, it should be understood that the present invention is not limited to or defined by what is shown or discussed herein.

Moreover, as one of ordinary skill in the art will appreciate, any digital computer systems can be configured or otherwise programmed to implement the methods and apparatuses disclosed herein, and to the extent that a particular digital computer system is configured to implement the methods and apparatuses of this invention, it is within the scope and spirit of the present invention. Once a digital computer system is programmed to perform particular functions pursuant to computer-executable instructions from program software that implements the present invention, it in effect becomes a special purpose computer particular to the present invention. The techniques necessary to achieve this are well known to those skilled in the art and thus are not further described herein.

Computer executable instructions implementing the methods and techniques of the present invention can be distributed to users on a computer-readable medium and are often copied onto a hard disk or other storage medium. When such a program of instructions is to be executed, it is usually loaded into the random access memory of the computer, thereby configuring the computer to act in accordance with the techniques disclosed herein. All these operations are well known to those skilled in the art and thus are not further described herein. The term “computer-readable medium” encompasses distribution media, intermediate storage media, execution memory of a computer, and any other medium or device capable of storing for later reading by a computer a computer program implementing the present invention.

Accordingly, drawings, tables, and description disclosed herein illustrate technologies related to the invention, show examples of various embodiments of the present invention and provide examples of using various embodiments of the present invention and are not to be construed as limiting the present invention. Known methods, techniques, or systems may be discussed above without giving details, so to avoid obscuring the principles of the invention. As will be appreciated by one of ordinary skill in the art, the present invention can be implemented, modified, or otherwise altered without departing from the principles and spirit of the present invention. Therefore, the scope of the present invention should be determined by the following claims and their legal equivalents.

1. A method comprising:
proactively monitoring and collecting, by an activity monitoring module running on a mobile device, activity stream data, wherein the activity stream data includes information regarding context and usage of one or more applications installed on the mobile device by identifying at various points in time one or more of applications, application processes or tasks currently running on the mobile device and a current state associated with the applications, the application processes or the tasks; and
providing, by the activity monitoring module, the activity stream data to a central server that collects activity stream data from a plurality of mobile devices, including the mobile device, and processes the collected activity stream data in conjunction with auxiliary data to create derived mobile user activity profiles for users of the plurality of mobile devices, wherein the auxiliary data includes one or more of information characterizing a type or nature of a plurality of mobile applications and information characterizing a type or nature of a particular location.

2. The method of claim 1, wherein the activity monitoring module comprises an application for performing user, application and device activity monitoring.

3. The method of claim 2, wherein the activity monitoring module comprises an application for performing user, application and device activity monitoring; and wherein the method further comprises obtaining activity stream data as a result of data proactively reported via an application programming interface (API) of the application by one or more other applications installed on the mobile device.

4. The method of claim 3, wherein the data proactively reported comprises custom activities and events defined by application developers of the one or more other applications and that are to be made part of the derived mobile user activity profiles.

5. The method of claim 1, wherein the activity stream data includes context data comprising one or more of metadata associated with the usage of the one or more applications, a location of the mobile device during the usage, a battery level during the usage, a time of day at which the usage was initiated, a time of date at which the usage was completed and information regarding concurrently active applications during the usage.

6. The method of claim 5, wherein the metadata comprises information relating to one or more activities performed on the mobile device preceding the usage.

7-8. (canceled)

9. The method of claim 1, further comprising receiving, by the activity monitoring module, a mobile ad targeting a user of the mobile device based on one of the derived mobile user activity profiles.

10. A method comprising:
maintaining, by a central server, a database of auxiliary data including one or more of information characterizing a type or nature of a plurality of mobile applications; and information characterizing a type or nature of a particular location;
receiving, by the central server, activity stream data from a plurality of mobile devices, wherein the activity stream data includes information regarding context and usage of one or more applications installed on the plurality of mobile devices that has been proactively monitored and collected by identifying at various points in time one or more of applications, application processes or tasks currently running on each of the plurality of mobile devices and a current state associated with the applications, the application processes and the tasks;
creating, by the central server, derived mobile user activity profiles for individual users of the plurality of mobile devices by processing the activity stream data in conjunction with the auxiliary data.

11. The method of claim 10, further comprising:
receiving, by the central server, from a publisher, an ad request containing a unique identifier identifying a mobile user of the individual users;
receiving, by the central server, from a plurality of advertisers, ad objects containing advertising content, bid amounts and targeting criteria;
selecting, by the central server, an ad object of the ad objects based on a derived mobile user activity profile of the derived mobile user activity profiles that is associated with the mobile user and the targeting criteria.

12. The method of claim 11, further comprising responsive to the ad request, returning to the publisher, by the central server, the advertising content of the selected ad object for display to the mobile user.

13. The method of claim 12, wherein said selecting an ad object further comprises:
identifying, by the central server, a plurality of candidate ad objects of the ad objects that contain targeting criteria matching one or more characteristics of the derived mobile user activity profile;
ranking, by the central server, the plurality of candidate ad objects based on a predicted revenue metric; and
selecting, by the central server, the ad object that maximizes the predicted revenue metric.

14. The method of claim 13, wherein:
the predicted revenue metric is based on one or both of a set of ad statistics and a per-user relevance score; and
the set of ad statistics includes one or more of previous ad object performance and bid per ad object; and
the per-user relevance score is based on one or more of previous ad object interactions and the derived mobile user activity profile.

15. The method of claim 10, further comprising:
receiving, by the central server, targeting criteria, from an advertiser, defining a group of users of the plurality of mobile devices to receive an advertisement, the targeting criteria specifying a set or sequence of user activities including one or more of: installing of a particular mobile application, uninstalling of the particular mobile application, usage of the particular mobile application, performance of a specific task within the particular mobile application, purchasing of a digital good, sharing of digital content related to the advertisement; and
sending, by the central server, the advertisement for display on mobile devices of the plurality of mobile devices that are associated with the group of users.

16. The method of claim 15, wherein the targeting criteria further specify a location or a set of locations.

17. A system comprising:
a plurality of mobile devices, wherein each mobile device of the plurality of mobile devices has installed thereon an activity monitoring module that proactively monitors and collects activity stream data including information regarding context and usage of one or more applications installed on the mobile device by identifying at various points in time one or more of applications, application processes and tasks currently running on each of the plurality of mobile devices and a current state associated with the applications, the application processes and the tasks; and
a central server which receives the collected activity stream data from the plurality of mobile devices, processes the collected activity stream data in conjunction with auxiliary data to create a derived profile for each of a plurality of mobile users of the plurality of mobile devices, wherein the auxiliary data includes one or more of information characterizing a type or nature of a plurality of mobile applications and information characterizing a type or nature of a particular location.

18. The system of claim 17, wherein the activity monitoring module further tracks impressions, clicks and conversions of ads displayed to the mobile user of the mobile device.

19. The system of claim 18, wherein the activity monitoring module further periodically syncs the collected activity stream data and the tracked impressions, clicks and conversions with the central server.

20. The system of claim 17, wherein the central server includes:
a plurality of web-endpoints to interface with the plurality of mobile devices, the plurality of mobile users and a plurality of stakeholders; and
a plurality of data stores capable of storing user-meta-information, user activity logs, ad inventory, ad statistics and the derived profiles;
an ad engine capable of responding to ad requests with a plurality of relevant ads based on the derived profiles to maximize expected gain for the plurality of stakeholders;
a data processing module capable of batch processing information in the plurality of data stores to create derived information that can be viewed by the plurality of stakeholders and that can be used by the ad engine; and
an analytics engine capable of returning analytics data to authorized users.

21. The system of claim 20, wherein the authorized users include carriers and original equipment manufacturers (OEMs) and wherein the analytics data returned includes metrics and data pertaining to subscribers or customers of the authorized users.

22. The system of claim 21, wherein the analytics data returned is organized by one or more of applications, geography, cell phone network, mobile device operating system version and type of mobile device.
